(19) United States
(12) Patent Application Publication
(10) Pub. No.: US 2019/0284444 A1
(43) Pub. Date: Sep. 19, 2019

(54) AN ADHESIVE COMPOSITION AND AN ADHESIVE FILM OBTAINED THEREFROM

(71) Applicant: 3M INNOVATIVE PROPERTIES COMPANY, St. Paul, MN (US)

(72) Inventor: Liang Chen, Shanghai (CN)

(21) Appl. No.: 16/463,914

(22) PCT Filed: Nov. 28, 2016
(86) PCT No.: PCT/CN2016/107485

§ 371 Date: May 24, 2019

(51) Int. Cl. C09J 7/38; C09J 7/20

(52) U.S. Cl. CPC C09J 7/38; C09J 7/203; C09J 2203/326; C09J 2467/00; C09J 2483/00

(57) ABSTRACT

The present disclosure relates to an adhesive composition for forming an adhesive film and an adhesive film obtained therefrom. In the present disclosure, the adhesive composition comprises the following components: (A) a silicone gum having a functional group, which is capable of being cured by heat in the present of a curing agent; (B) a thermoplastic polymer; (C) a curing agent; and (D) a solvent; wherein a weight ratio of the silicone gum to the thermoplastic polymer is in a range of 0.3:10 to 5:10. The adhesive composition is able to form an adhesive film with excellent adhesion strength at not only room temperature but also at a high temperature.

### TECHNICAL FIELD

The present disclosure relates to a thermosetting adhesive and an adhesive film. More specifically, the present disclosure relates to an adhesive composition and an adhesive film obtained from the adhesive composition, which shows excellent properties including but not limited to adhesion strength, heat resistance and short curing time.

### BACKGROUND ART

Thermosetting adhesive, in a form of glue or film, has extensive application in semiconductor area e.g. in the packaging of integrated circuits containing e.g. Metal-Oxide-Semiconductor Field-Effect Transistors (MOSFETs), in which different electronic parts need to be bonded. The thermosetting film is generally obtained from an adhesive composition via a crosslinking reaction (which is also referred to as “curing” in the present application) which is initiated by heating or irradiation with or without pressure being applied.

### SUMMARY OF THE INVENTION

In the present disclosure, an adhesive composition and an adhesive film obtained from the adhesive composition are developed to provide a solution for bonding in the field requiring good adhesion strength, heat resistance and other functional properties such as short curing time.

In an aspect, the present disclosure provides an adhesive composition, comprising the following components:

(A) a silicone gum having a crosslinkable functional group, which is capable of being cured in the present of a curing agent;

(B) a thermoplastic polymer;

(C) a curing agent; and

(D) a solvent which is capable of dissolving the silicone gum and the thermoplastic polymer to form a coating solution for obtaining an adhesive film;

wherein a weight ratio of the silicone gum to the thermoplastic polymer is in a range of 0.3:10 to 5:10.

According to another aspect of the present disclosure, the functional group is one or more groups selected from a vinyl group, a phenyl group, a fluoride group, an isocyanate group and an alkoxysilicon group.

According to another aspect of the present disclosure, the silicone gum includes a vinyl terminated silicone resin, a silicone resin containing branched vinyl group, or a vinyl terminated silicone resin containing branched vinyl group, preferably one or more of vinyl terminated polydimethylsiloxane (Vi-PDMS) and vinyl terminated polymethylphenylsiloxane (Vi-PMVS). As used herein, the term “silicon gum” refers to organopolysiloxanes having sufficiently high molecular weight (Mw) (generally, a number average molecular weight thereof is in a range of about 5000 to about 10,000,000) to provide kinetic viscosities greater than 500,000 cSt at 25° C., optionally, the organopolysiloxane is mixed with fillers such as nano-sized silicon oxide when necessary such that the mechanical strength of the cured products e.g. cured film is enhanced.

According to another aspect of the present disclosure, the thermoplastic polymer is dissolvable in the solvent and is capable of being mixed with the silicone gum to form a coating solution which is being able to be coated and dried into a film.

According to another aspect of the present disclosure, the thermoplastic polymer is a thermoplastic polyester elastomer selected from one or more of polyurethane, or a thermoplastic polyester elastomer (TPEE) preferably polyethylene terephthalate and polyethylene naphthalate.

According to another aspect of the present disclosure, the thermoplastic polyester elastomer is a saturated polyester or an unsaturated polyester. In the case that a self-standing adhesive film obtained by releasing an adhesive film coated onto a release liner is produced, a saturated polyester is used; in the case that an adhesive film supported by a carrier which is not released is produced, a saturated polyester or an unsaturated polyester can be used.

According to another aspect of the present disclosure, the adhesive composition further comprises (E) an adhesion promoter.

According to another aspect of the present disclosure, an adhesive film obtained from the adhesive composition according to the present disclosure is provided.

According to another aspect of the present disclosure, a method for producing the adhesive film according to the present disclosure is provided, comprising:

i) dissolving a silicone gum, a thermoplastic polymer and a curing agent into a solvent respectively, to obtain a solution (A), solution (B) and solution (C) respectively;

ii) mixing the solution (A), the solution (B) and the solution (C) to obtain a mixed solution;

iii) adding an adhesion promoter into the mixed solution to obtain a coating solution;

iv) coating the coating solution onto a carrier, followed by drying, to obtain an adhesive film.

According to another aspect of the present disclosure, the curing of the adhesive composition and the adhesive film obtained therefrom is carried out at a temperature of 150° C. or lower, preferably 140° C. or lower, more preferably 130° C. or lower, more preferably 120° C. or lower, for a period of less than 10 minutes, preferably less than 9 minutes, more preferably less than 8 minutes, more preferably less than 7 minutes, more preferably less than 6 minutes, more preferably within 5 minutes.

In the present disclosure, the adhesive composition and the adhesive film obtained from the adhesive composition of the present disclosure can be cured within a relative shorter time at a relative lower temperature under a pressure of a range of 0.2 Mpa to 0.8 Mpa, preferably 0.3 Mpa to 0.7 Mpa, more preferably 0.4 Mpa to 0.6 Mpa, e.g. the adhesive film of the present disclosure can be cured at a temperature of less than 150° C., preferably less than 140° C., more preferably less than 130° C., more preferably less than 120° C., for a period of less than 10 minutes, preferably less than 9 minutes, more preferably less than 8 minutes, more preferably less than 7 minutes, more preferably less than 6 minutes, more preferably within 5 minutes.

Moreover, the adhesive composition and the adhesive film obtained from the adhesive composition of the present disclosure shows excellent adhesion strength not only under room temperature but also under high temperature. In other words, although curing time for the adhesive composition of the present disclosure and accordingly the adhesive film obtained therefrom is shortened, the adhesion strength and the heart resistance of the adhesive composition of the present disclosure and accordingly the adhesive film obtained therefrom are increased.

According to a further aspect, the present disclosure also provides a use of the adhesive composition of the present disclosure in the formation of an adhesive film which shows excellent adhesion strength and heat resistance.

### BRIEF DISCRIPTION OF DRAWINGS

FIG. 1 shows a film formed according to example 3 of the present disclosure;

FIG. 2 shows a separated mixture formed according to example 13 of the present disclosure;

FIG. 3 shows a sample prepared for adhesion strength test;

FIG. 4 shows the rheology test for the formulation #3 and for ES-365;

FIG. 5 shows an adhesive film with both surfaces thereof are covered by a fluoride liner which can be released;

FIG. 6 shows an adhesive with the one surface thereof is covered by a fluoride liner which can be released and the other surface thereof is covered by a carrier which can not be released.

### DETAILED DESCRIPTION OF THE INVENTION

It shall be understood that one skilled in the art can contemplate other various embodiments and make modifications to the present disclosure according to the teachings of the description without departing from the scope or spirit of the present disclosure. Therefore, the following embodiments are not intended to be limiting in any sense.

Unless otherwise specified, it shall be understood that all numbers which are used in the description and claims to represent feature sizes, quantities and physicochemical characteristics are modified by the term “approximate” in all cases. Therefore, unless otherwise oppositely stated, numerical parameters which are listed in the description and claims attached thereto are approximate values. One skilled in the art can properly change these approximate values according to the teachings disclosed herein so as to obtain desired characteristics. Numerical ranges which are expressed by using end points shall include all numbers and any range therein. For instance, the range 1-5 includes 1, 1.1, 1.3, 1.5, 2, 1.75, 3, 3.80, 4, and 5, etc.

Unless otherwise specified, it shall be understood that, the ratio in the present disclosure refers to the weight ratio of the components in the composition in solid content basis, i.e. the solvent for dissolving the component is excluded.

The components as used in the present disclosure will be described in detail below.

(A) The Silicone Gum

The silicone gum having a functional group is contained in the adhesive composition to provide adhesive film obtained from the adhesive composition with good adhesion strength and heat resistance. In addition, the silicone gum imparts the adhesive film with essential mechanical strength and rigidity.

According to certain embodiments, the silicone gum includes a vinyl terminated silicone resin, a silicone resin containing branched vinyl group, or a vinyl terminated silicone resin containing branched vinyl group, which can be cured by heat in the presence of a curing agent (initiator) e.g. benzoyl peroxide (BPO), to form elastomer.

According to certain embodiments, the silicone gum can be dissolved in some solvents e.g. toluene, xylene or heptane, so as to form a solution (A) which will be subsequent mixed with the other components of the present disclosure (the other components are dissolved in the solvent also and are provided in a form of solution also), which in turn forms a coating solution for the formation of the adhesive film.

(B) The Thermoplastic Polymer

The thermoplastic polymer is a thermoplastic adhesive, which is contained in the adhesive composition to provide an adhesive film with high adhesion to a substrate.

According to certain embodiments, the thermoplastic polymer is dissolvable in the solvent e.g. toluene or xylene and is capable of being mixed with the silicone gum to form a coating solution which is being able to be coated and dried into a film.

According to certain embodiments, the thermoplastic polymer is selected from one or more of a thermoplastic polyester elastomer preferably polyurethane, or polyethylene terephthalate and polyethylene naphthalate.

The polyester comprises a dicarboxylic acid unit and a glycol unit, wherein the dicarboxylic acid unit preferably comprises one or more of succinic acid, adipic acid, cyclohexane diacid, suberic acid, phthalic acid, naphthalene acid, trimellitic acid, pyromellitic acid, and the glycol unit preferably comprises one or more ethylene glycol, propylene glycol, butanediol, pentanediol, hexanediol, octanediol, decanediol, diethylene glycol, dipropylene glycol, dimethylolpropane, and dimethylolethane. Preferably the polyester comprises an aromatic segment either in the dicarboxylic acid unit or in the glycol unit.

As exemplary examples, the polyesters is one or more of the polyethylene terephthalate (PET), poly(butylene terephthalate), phthalate polyester, adipate polyester.

According to certain embodiments, the thermoplastic polymer is selected from one or more of a thermoplastic polyester elastomer (TPEE), or polyurethane, in which the thermoplastic polyester elastomer is a saturated polyester or an unsaturated polyester.

According to certain embodiments, the thermoplastic polyester elastomer is incorporated into the adhesive composition such that the weight ratio of the silicone gum to the thermoplastic polymer is in a range of 0.3:10 to 5:10, 0.4:10 to 4.5:10; preferably 0.5:10 to 4.0:10, more preferably 1.0:10 to 3.5:10, further preferably 1.5:10 to 3.0:10, preferably 2.0:10 to 2.5:10.

When the weight ratio of the silicone gum to the thermoplastic polymer is less than 0.3:10, the heat resistance of the obtained adhesive film is decreased; when the weight ratio of the silicone gum to the thermoplastic polymer is greater than 5:10, it is difficult to form a film. When the weight ratio of the silicone gum to the thermoplastic polymer is in a range of 0.3:10 to 5:10, a uniform adhesive film with excellent heat resistance is obtained.

(C) The Curing Agent

In the present disclosure, a curing agent is contained in the adhesive composition to accelerate the curing of silicone under high temperature, and upon heat activation, the functional group of the silicone gum will react with the curing agent thereby crosslinking the silicone gum to obtain a cured film.

When the curing agent is incorporated into the adhesive composition, the curing of silicone under high temperature is accelerated, and when the content of the curing agent is increased within the range of the present disclosure, the mechanical properties e.g. the adhesion strength and the heat resistance are increased.

According to certain embodiments, the curing agent is selected from peroxide, preferably benzoyl peroxide including 4,4′-dimethyldibenzoyl peroxide, 3,3′-dimethyldibenzoylperoxide, 2,2′-dimethyldibenzoyl peroxide, 2,2′,4,4′-tetrachlorodibenzoyl peroxide, 2,4-Dichlorobenzoyl peroxide, Methyl ethyl ketone peroxide, Methyl isopropyl ketone peroxide, cumyl peroxide, 2,5-dimethyl-2,5-di(t-butyl peroxy)hexane.

According to certain embodiments, a weight ratio of the curing agent to the thermoplastic polymer is in a range of 0.1:10 to 0.5:10, preferably 0.15:10 to 0.4:10, more preferably 0.2:10 to 0.3:10.

When the content of the curing agent is increased within the range of the present disclosure, the mechanical properties e.g. the adhesion strength and the heat resistance are increased.

(D) The Solvent

In the present disclosure, a solvent is contained in the adhesive composition to dissolve each component in the adhesive composition, so as to form different solutions, which will be mixed subsequently to obtain a coating solution for formation of the adhesive film of the present disclosure.

According to certain embodiments, the solvent is one or more of aromatic hydrocarbon solvents such as toluene and xylene; linear or branched aliphatic hydrocarbon solvents such as hexane, heptane, octane, isooctane, decane, cyclohexane, methylcyclohexane and isoparaffin; hydrocarbon solvents such as industrial gasoline, petroleum benzine and solvent naphtha; ketone solvents such as acetone, methyl ethyl ketone, methyl isobutyl ketone, diisobutyl ketone, acetonitrile acetone and cyclohexanone, ester solvents such as ethyl acetate, propyl acetate, isopropyl acetate, butyl acetate and isobutyl acetate; ether solvents such as diethyl ether, dipropyl ether, diisopropyl ether, dibutyl ether, preferably one or more of toluene, heptane, or xylene.

(E) The Adhesion Promoter

In the present disclosure, the incorporation of an adhesion promoter into the adhesive composition increases the adhesion strength to the substrate.

In the present disclosure, a weight ratio of the adhesion promoter to the thermoplastic polymer is in a range of 0.1:10 to 0.5:10, preferably 0.15:10 to 0.4:10, more preferably 0.2:10 to 0.3:10.

In the present disclosure, when the adhesion promoter is incorporated into the adhesive composition, since the adhesion promoter is in fact a coupling agent which is capable of reacting with silicone and substrate surface to form a chemical bonding therebetween, the adhesion strength is increased not only under room temperature but also under high temperature.

In the present disclosure, through the combination of the adhesion promoter and the other components e.g. the silicone gum and the thermoplastic polyester elastomer, the adhesive film obtained from the adhesive composition not only shows excellent adhesion strength to the substrate but also shows excellent heat resistance. That is to say, the adhesive film obtained from the adhesive composition of the present disclosure not only shows excellent adhesion strength under room temperature, but also shows excellent adhesion strength under high temperature e.g. under a temperature of about 90° C.

The adhesive composition according to the present disclosure achieved a beneficial balance among the adhesive strength, heat resistance, film formation and curing time. In other words, the adhesive film obtained from the adhesive composition shows excellent adhesion strength not only under low temperature but also under high temperature, in the meanwhile, the adhesive film can be cured within short time, which reduces the process time also.

Additives

In addition to the above components, when necessary, the adhesive composition of the present disclosure may comprise one or more of the following components, such as fillers, antioxidants, antifoaming agents, and surfactant.

When necessary, the fillers can be contained in the adhesive composition to modify or improve the properties of the adhesive composition, in which the fillers can be selected from conductive filler such as carbon black, nickel powder, copper powder, golden power, silver powder; thermal conductive filler such as boron nitride (BN), aluminum hydride (ATH); or other fillers such as CaCO₃, SiO₂, clay, chalk, glass fibers and so on.

According to certain embodiments, an antioxidant can be further contained in the adhesive composition to provide an advantage of better aging performance. According to certain embodiments, the antioxidant can be selected from the group consisting of tea polyphenols, Vitamin E, flavonoid, Butylated hydroxyanisole, Butylated hydroxytoluene, tert-Butyl hydroquinone.

According to certain embodiments, an antifoaming agent can be further contained in the adhesive composition to provide an advantage of good coating surface. According to certain embodiments, the antifoaming agent can be selected from the group consisting of insoluble oils, polydimethylsiloxanes and certain alcohols, stearates and glycols.

According to certain embodiments, a surfactant can be further contained in the adhesive composition to provide an advantage of good surface of the coating. According to certain embodiments, the surfactant can be selected from the group consisting of sulfate, sulfonate, phosphate, ammonium lauryl sulfate, sodium lauryl sulfate (SDS, sodium dodecyl sulfate) and the related alkyl-ether sulfates sodium laureth sulfate, also known as sodium lauryl ether sulfate (SLES), and sodium myreth sulfate.

In the present disclosure, the above mentioned components may be mixed together with solvents to form an adhesive ready to use. And the obtained adhesive composition may be applied to the surface of a device such as electronic device by commonly known coating methods and then be cured to provide an effective adhesion. Alternatively, the adhesive composition may be applied to the surface of a liner such as a sheet, a film, a plate, a tape and then be dried to provide a film which can be stored at a normal environment in a package or in a rolling form. Upon application, the film may be applied to the devices and if necessary be cured at a relatively high temperature and suitable pressure to provide a cured article with excellent adhesion strength and heat resistance.

### EXAMPLES

Hereinafter, the present disclosure is further described with reference to the following examples, which are provided in the present disclosure for illustrative purpose and are not for limiting the scopes of the present disclosure.

Raw Materials

The Raw materials used in the following illustrative examples of the present disclosure were commercial available and were listed in the following Table 1 by the trade name and the vendor, the function of the component was illustrated also.

TABLE 1
Raw Materials

| Raw | | |
|---|---|---|
| Materials | Function | Vendor name |
| 2420-40 | A vinyl terminated silicone gum | Dowcorning |
| ES-365 | A thermoplastic ester elastomer | SK Chemical |
| 4030AC | Ethylene vinyl acetate (EVA) | Celanese Corporation |
| Macromelt | PA (polyamide) hotmelt adhesive | Henkel |
| 6239 | | |
| BPO | Peroxide curing agent | Akzo Nobel |
| GZ-14 | Adhesion promoter | Runhe Silicone |
| Toluene | Solvent | Sinopharm group Co. ltd. |
| IPA | Solvent | Sinopharm group Co. ltd. |

Base Solution Preparation

To prepare the adhesive compositions of the present disclosure, each component of the adhesive composition was dissolved in a solvent to prepare base solutions A-D, as summarized in following table 2.

TABLE 2
Base Solutions Preparation

| | Formulation (wt %) | | | | | | | |
|---|---|---|---|---|---|---|---|---|
| | ES-365 | 2420-40 | 4030AC | Macromelt 6239 | BPO | Toluene | IPA | Solid wt % |
| Solution A | 30.0 | — | — | — | | 70.0 | — | 30 |
| Solution B | — | 20.0 | — | — | | 80.0 | — | 20 |
| Solution C | — | — | — | — | 10.0 | 90.0 | — | 10 |
| Solution D | — | — | 20.0 | — | — | 80.0 | — | 20 |
| Solution E | — | — | — | 30.0 | — | 35.0 | 35.0 | 30 |

Note: macromelt 6239 is a kind of thermoplastic polyimide which can't be dissolved by only toluene, but can be dissolved in the mixture solvent of toluene and IPA (isopropanol).

Test Methods

The film formation checking test was conducted to evaluate the film formation of the adhesive compositions of the present disclosure, the adhesion strength of the adhesive compositions of the present disclosure was evaluated by a “peel force test”, the heat resistance of the adhesive compositions of the present disclosure was evaluated by comparison of the adhesion strength of the adhesive compositions of the present disclosure under room temperature of 25° C. and under a high temperature of 90° C., and the heat resistance of the adhesive compositions of the present disclosure was further evaluated by a rehology test.

Film Formation Checking Test

The materials as shown by the following table 3 were mixed uniformly and coated onto a fluoride release liner, subsequent by drying at a temperature of 65° C. for 10 minutes, to check whether a film is formed or not.

TABLE 3
The film formation checking test for examples 1-15 of the present disclosure

| | Solution A | Solution B | Solution D | Solution E | Mix ratio | Film Formation or not |
|---|---|---|---|---|---|---|
| Example 1 | 100.0 | 16.0 | — | — | 10:1.1 | Yes |
| Example 2 | 100.0 | 32.0 | — | — | 10:2.1 | Yes |
| Example 3 | 100.0 | 48.0 | — | — | 10:3.2 | Yes |
| Example 4 | 100.0 | 62.0 | — | — | 10:4.1 | Yes |
| Example 5 | 100.0 | 80.0 | — | — | 10:5.3 | No |
| Example 6 | — | 10.7 | 100.0 | — | 10:1.1 | Yes |
| Example 7 | — | 21.3 | 100.0 | — | 10:2.1 | Yes |
| Example 8 | — | 32.0 | 100.0 | — | 10:3.2 | Yes |
| Example 9 | — | 41.3 | 100.0 | — | 10:4.1 | Yes |
| Example 10 | — | 53.3 | 100.0 | — | 10:5.3 | No |
| Example 11 | — | 16.0 | — | 100.0 | 10:1.1 | Mixture is separated |
| Example 12 | — | 32.0 | — | 100.0 | 10:2.1 | Mixture is separated |
| Example 13 | — | 48.0 | — | 100.0 | 10:3.2 | Mixture is separated |
| Example 14 | — | 62.0 | — | 100.0 | 10:4.1 | Mixture is separated |
| Example 15 | — | 80.0 | — | 100.0 | 10:5.3 | Mixture is separated |

Mix ratio = Weight (ES-365):Weight (2420-40)

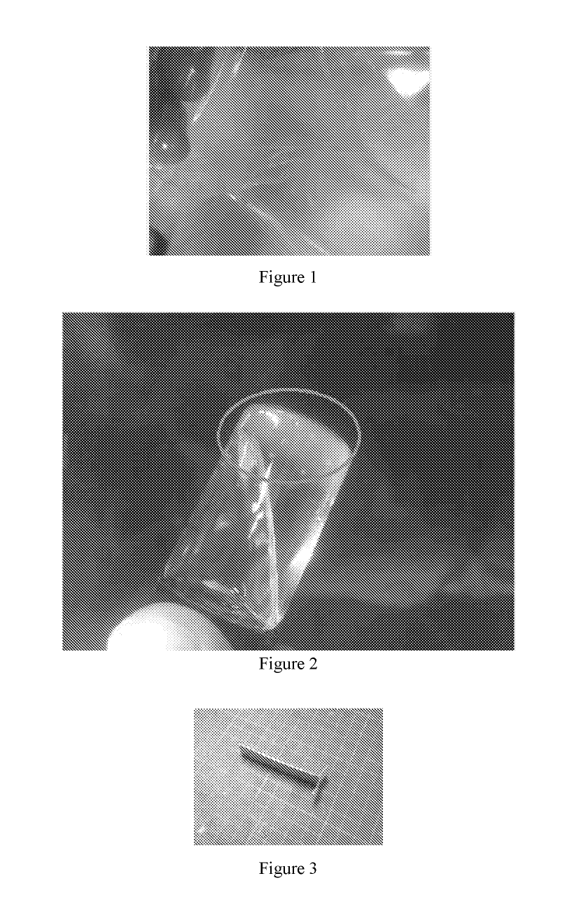

As can be from the above examples 1 to 5, when the mix ratio of the 2420-40 (silicone gum) to the ES-365 (thermoplastic ester elastomer) is greater than 5:10, a film can not be successfully formed; when the mix ratio of the mix ratio of the 2420-40 (silicone gum) to the ES-365 (thermoplastic ester elastomer) is in a range of 0.3:10 to 5:10, a film with excellent heat resistance can be formed successfully, in which FIG. 1 shows a film formed according to example 3 of the present disclosure. When the mix ratio of the mix ratio of the 2420-40 (silicone gum) to the ES-365 (thermoplastic ester elastomer) is too small, e.g. less than 0.3:10, although the film still can be formed, the heat resistance of the film is decreased to some extent. The same applies for the system involving EVA and 2420-40. For the system involving macromelt 6239 (which is a kind of thermoplastic polyamide) and 2420-40, since the silicone can't be dissolved in IPA, so when solution E contained with IPA and polyamide is mixed with the solution B which contain silicone, the separation was appear, and the mixture can't be coated onto a liner to form a film, in which FIG. 2 shows a film formed according to example 13 of the present disclosure.

Peel Force Test

Peel force test was conducted to evaluate the adhesion strength of the adhesive film obtained from the adhesive composition of the present disclosure. The test method of peel force was referred to “ASTM D3330”, which was a commonly used test method in the art, the detailed procedure was briefly summarized as follows.

The adhesive composition was coated onto a fluoride release liner, subsequent by drying under 65° C. for 10 minutes, to obtain an adhesive film with a thickness of about 75 μm. 180° peel was used to check the bonding strength (adhesion strength). In 180° peel test, the adhesive film with a width of 16 mm and a length of 80 mm was placed between two pieces of Al tape, the width of Al tape is 16 mm; then, put the adhesive film sandwiched by the two pieces of Al tape between two pieces of liner, and thermal bonding was carried out by hot press under 150° C. for 5 minutes under a pressure of 0.7 Mpa; subsequently, the liner is peeled off from the adhesive film, the 180° peel force was tested at the speed of 2 inch/min on Instron tester in accordance with ASTM D3330. A sample prepared for adhesion strength test is illustrated in FIG. 3.

### Formulation and Testing Examples

### Example 16

In example 16, a peroxide curing agent BPO was incorporated into the adhesive composition of the present disclosure.

TABLE 4
different percentage of peroxide curing agent
BPO vs. adhesion strength.

| Formulation | Solution A | Solution B | Solution C | Peel Force (N/mm) |
|---|---|---|---|---|
| # 1 | 100.0 | 48.0 | 0.40 | 0.56 |
| # 2 | 100.0 | 48.0 | 6.0 | 0.71 |

As can be seen from the above, when the percentage of the peroxide is increased within the range of the present disclosure, not only the curing rate was increased, but also the adhesion strength was increased. Moreover, the peroxide curing agent BPO can accelerate the curing of the silicone under high temperature, the mechanical properties and heat resistance of the formulation was increased.

### Example 17

In example 17, GZ-14 (which is a silane coupling agent acting as an adhesion promoter) was incorporated into the adhesive composition of the present disclosure.

TABLE 5
the peel force of the adhesive composition of the present disclosure
under room temperature (RT) for different formulations

| | | | | | Peel Force |
|---|---|---|---|---|---|
| | | | | | (N/mm), |
| | | | | | Room |
| Formulation | Solution A | Solution B | Solution C | GZ-14 | Temperature |
| # 2 | 100.0 | 48.0 | 6.0 | — | 0.71 |
| # 3 | 100.0 | 48.0 | 6.0 | 1.0 | 0.82 |
| # 4 | 100.0 | 62.0 | 6.0 | — | 0.50 |
| # 5 | 100.0 | 62.0 | 6.0 | 1.0 | 0.90 |

As can be seen from the above, when GZ-14 (which is a silane coupling agent, acting as an adhesion promoter) was incorporated into the adhesion composition of the present disclosure, since GZ-14 can act us a coupling agent to react with silicone and substrate surface, through the combination of GZ-14 with silicone gum and thermoplastic ester elastomer, the adhesion strength to the substrate surface was increased, as verified by formulations #3 and #5, which is unexpected for a person skilled in the art. In contrast, when GZ-14 was not incorporated into the adhesion composition of the present disclosure, the adhesion strength was built up by the thermoplastic material ES-365, so the peel force was decreased, as verified by formulations #2 and #4.

To check the heat resistance of the adhesive composition of the present disclosure and the adhesive film obtained thereof, an adhesive film sample was obtained by the above mentioned procedure, and the peel force under high temperature was tested for the adhesive film sample and the rheology was tested by a TA analyzer.

TABLE 6
formulation and Peel Force Tested under room temperature (RT) and 90° C.

| | | | | | Peel Force under | Peel Force under |
|---|---|---|---|---|---|---|
| Formulation | Solution A | Solution B | Solution C | GZ-14 | RT (N/mm) | 90° C. (N/mm) |
| # 3-1 | 100.0 | 20 | 6.0 | 1.0 | 0.66 | 0.58 |
| # 3-2 | 100.0 | 10 | 6.0 | 1.0 | 0.65 | 0.47 |
| # 3-3 | 100.0 | 5 | 6.0 | 1.0 | 0.56 | 0.34 |
| # 2 | 100.0 | 48.0 | 6.0 | — | 0.71 | 0.43 |
| # 3 | 100.0 | 48.0 | 6.0 | 1.0 | 0.82 | 0.61 |
| # 4 | 100.0 | 62.0 | 6.0 | — | 0.50 | 0.41 |
| # 5 | 100.0 | 62.0 | 6.0 | 1.0 | 0.90 | 0.87 |
| ES-365 | — | — | — | — | 1.36 | 0.06 |

As can be seen from the above, compared with the thermoplastic material ES-365, which showed a high adhesion strength under room temperature while the adhesion strength was dramatically decreased to nearly zero under a high temperature of 90° C., the adhesion composition of the present disclosure showed significant increase of heat resistance, and adhesion composition can maintain a relative high adhesion strength (bonding strength) under a high temperature of 90° C.

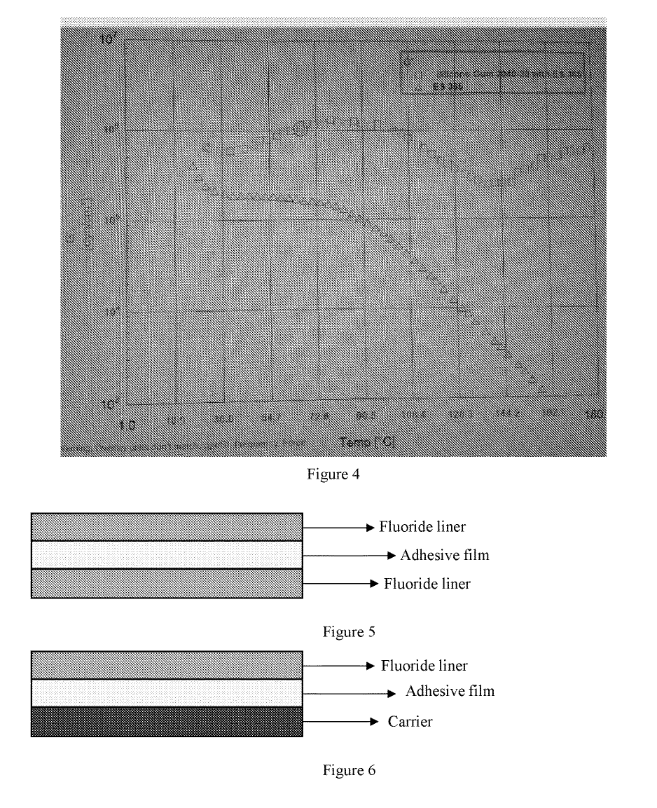

To check the cure procedure, TA rheology analyzer is used to follow the cure step, and FIG. 4 shows the rheology test for the formulation #3 and for ES-365.

As can be seen from FIG. 4, the elastic modulus G of ES-365 was decreased with the increasing of the temperature and the elastic modulus G was very low at a higher temperature of about 150° C.; however, with the incorporation of heat cured silicone, the physical property was maintained at a higher temperature of about 150° C., and even increased under a high temperature of above 150° C., which is unexpected for a person skilled in the art.

From the results, it can be concluded that incorporation of the silicone gum into the adhesive composition of the present disclosure leads to increasing of the elastic modulus of the adhesive composition, which in turn leads to increasing of the heat resistance of the adhesive composition of the present disclosure.

In the present disclosure, when the adhesive composition was cured under a high temperature, the silicone gum imparted high temperature resistant property to the formulation, such that the peel force can be maintained even at a high temperature of 90° C.

### Example 18

In this example, as shown by following table 7, solution D containing thermoplastic polymer EVA was mixed with solution B containing silicone, the obtained mixture was further mixed with solution C, or mixed with solution C and GZ-14, to obtain coating solutions which was subsequently coated onto a liner followed by drying to obtain a film and the adhesion performance of the film was evaluated.

TABLE 7
formulation and peel force tested under RT

| | | | | | Peel Force |
|---|---|---|---|---|---|
| | | | | | under RT |
| Formulation | Solution D | Solution B | Solution C | GZ-14 | (N/mm) |
| # 6 | 100.0 | 32.0 | 6.0 | — | 0.67 |
| # 7 | 100.0 | 32.0 | 6.0 | 1.0 | 0.83 |
| # 8 | 100.0 | 41.3 | 6.0 | — | 0.68 |
| # 9 | 100.0 | 41.3 | 6.0 | 1.0 | 0.82 |

As can be seen from the above, when GZ-14 (which is a silane coupling agent acting as an adhesion promoter) was incorporated into the adhesive composition of the present disclosure, i.e. when GZ-14 was combined with solution D, B and C to obtain a coating solution (which is also referred as an adhesive composition in the present disclosure), the peel force under room temperature is increased, as verified by formulations #7 and #9. In contrast, when GZ-14 was not incorporated into the adhesion composition, the adhesion strength was built up by the thermoplastic material 4030AC, the peel force was decreased, as verified by formulations #6 and #8.

TABLE 8
formulation and peel force tested under RT and 90° C.

| | | | | | Peel Force under | Peel Force under |
|---|---|---|---|---|---|---|
| Formulation | Solution D | Solution B | Solution C | GZ-14 | RT (N/mm) | 90° C. (N/mm) |
| # 6 | 100.0 | 32.0 | 6.0 | — | 0.67 | 0.17 |
| # 7 | 100.0 | 32.0 | 6.0 | 1.0 | 0.83 | 0.25 |
| # 8 | 100.0 | 41.3 | 6.0 | — | 0.68 | 0.25 |
| # 9 | 100.0 | 41.3 | 6.0 | 1.0 | 0.82 | 0.49 |
| 4030AC | — | — | — | — | 0.74 | 0.06 |

As can be seen from the above, compared with thermoplastic material 4030AC, which shows a relative high adhesion strength under room temperature while the adhesion strength was dramatically decreased to nearly zero under a high temperature of 90° C., the adhesive film obtained from of the adhesion composition of the present disclosure showed increase of heat resistance, and the adhesive film can maintain adhesion strength (bonding strength) under a high temperature of 90° C.

Moreover, as can be seen from the above, formulation of 4030AC mixed with silicone gum showed not as good as the formulation of ES365 mixed with silicone gum in terms of adhesion strength (peel force) under high temperature.

Furthermore, the adhesive film obtained from the present disclosure can have both surface thereof covered by a liner e.g. a fluoride liner, as shown by FIG. 5. While using, the adhesive film is released from the liners and is used to bond two components e.g. two substrates together. The structure as shown by FIG. 5 can be obtained by coating the adhesive composition of the present disclosure onto a surface of a fluoride liner, followed by drying and covering another liner onto the adhesive film obtained after drying.

Alternatively, the adhesive film obtained from the present disclosure can be supported by a carrier which can not be released and the other surface of the adhesive film is covered by a liner e.g. a fluoride liner which can be released, as shown by FIG. 6. While using, the adhesive film is released from the liner and is used to bond to one component e.g. one substrate. The structure as shown by FIG. 6 can be obtained by coating the adhesive composition of the present disclosure onto a surface of a carrier, followed by drying and covering a liner which can be released onto the adhesive film obtained after drying.

Although the present disclosure have been described with reference to a number of illustrative examples as explained above, it should be understood that numerous other modifications and examples can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An adhesive composition, comprising the following components:
(A) a silicone gum having a crosslinkable functional group, which is capable of being cured in the present of a curing agent;
(B) a thermoplastic polymer which is a thermoplastic polyester elastomer;
(C) a curing agent comprising a peroxide; and
(D) a solvent which is capable of dissolving the silicone gum and the thermoplastic polymer to form a coating solution for obtaining an adhesive film;
wherein a weight ratio of the silicone gum to the thermoplastic polymer is in a range of 0.3:10 to 5:10.

2. The adhesive composition according to claim 1, wherein the functional group is one or more groups selected from a vinyl group, a phenyl group, a fluoride group, an isocyanate group and an alkoxysilicon group.

3. The adhesive composition according to claim 1, wherein the silicone gum is a vinyl terminated silicone resin, preferably one or more of vinyl terminated polydimethylsiloxane (Vi-PDMS) and vinyl terminated polymethylphenylsiloxane (Vi-PMVS).

4. The adhesive composition according to claim 1, wherein the thermoplastic polymer is dissolvable in the solvent and is capable of being mixed with the silicone gum to form a coating solution which is being able to be coated and dried into a film.

5. The adhesive composition according to claim 4, wherein the thermoplastic polymer is selected from one or more of polyurethane and a thermoplastic polyester elastomer including polyethylene terephthalate, polyethylene naphthalate.

6. The adhesive composition according to claim 5, wherein the thermoplastic polyester elastomer is a saturated polyester or an unsaturated polyester.

7. The adhesive composition according to claim 1, wherein the peroxide is selected from 4,4′-dimethyldibenzoyl peroxide, 3,3′-dimethyldibenzoyl peroxide, 2,2′-dimethyldibenzoyl peroxide, 2,2′,4,4′-tetrachlorodibenzoyl peroxide, 2,4-Dichlorobenzoyl peroxide, Methyl ethyl ketone peroxide, Methyl isopropyl ketone peroxide, cumyl peroxide, and 2,5-dimethyl-2,5-di(t-butyl peroxy)hexane.

8. The adhesive composition according to claim 1, wherein the solvent is one or more of: aromatic hydrocarbon solvents such as toluene and xylene; linear or branched aliphatic hydrocarbon solvents such as hexane, heptane, octane, isooctane, decane, cyclohexane, methylcyclohexane and isoparaffin; hydrocarbon solvents such as industrial gasoline, petroleum benzine and solvent naphtha; ketone solvents such as acetone, methyl ethyl ketone, methyl isobutyl ketone, diisobutyl ketone, acetonitrile acetone and cyclohexanone, ester solvents such as ethyl acetate, propyl acetate, isopropyl acetate, butyl acetate and isobutyl acetate; ether solvents such as diethyl ether, dipropyl ether, diisopropyl ether, dibutyl ether.

9. The adhesive composition according to claim 1, further comprising:
(E) an adhesion promoter.

10. The adhesive composition according to claim 9, wherein the adhesion promoter is a coupling agent capable of reacting with the silicone and a substrate surface during curing of the silicone gum, which is one or more of isocyanurates, methacryloxy silanes, aminoalkyl silanes, acryloxy silanes, alkoxy silanes, epoxy silanes, allylic alcohols, metal alkoxides, mercaptoalkyl silanes, allyl glycidyl ethers, silyl phosphates, titanate, borate, preferably a silane coupling agent, e.g. γ-(2,3-epoxy propoxy) propylmethyldiethoxysilane, γ-(methacryloxypropyl) trimethoxy silane.

11. The adhesive composition according to claim 1, wherein the weight ratio of the silicone gum to the thermoplastic polymer is in a range of 0.4:10 to 4.5:10; preferably 0.5:10 to 4.0:10, more preferably 1.0:10 to 3.5:10, further preferably 1.5:10 to 3.0:10, preferably 2.0:10 to 2.5:10.

12. The adhesive composition according to claim 1, wherein a weight ratio of the curing agent to the thermoplastic polymer is in a range of 0.1:10 to 0.5:10, preferably 0.15:10 to 0.4:10, more preferably 0.2:10 to 0.3:10.

13. The adhesive composition according to claim 9, wherein a weight ratio of the adhesion promoter to the thermoplastic polymer is in a range of 0.1:10 to 0.5:10, preferably 0.15:10 to 0.4:10, more preferably 0.2:10 to 0.3:10.

14. An adhesive film obtained from the adhesive composition according to claim 13.

15. The adhesive film according to claim 14, wherein the adhesive film is supported by a carrier.

16. The adhesive film according to claim 15, wherein the carrier is a release liner.

17. A method for producing the adhesive film according to claim 16, comprising:
i) dissolving a silicone gum, a thermoplastic polymer and a curing agent comprising a peroxide into a solvent respectively, to obtain a solution (A), solution (B) and solution (C) respectively;
ii) mixing the solution (A), the solution (B) and the solution (C) to obtain a mixed solution;
iii) adding an adhesion promoter into the mixed solution to obtain a coating solution;
iv) coating the coating solution onto a carrier, followed by drying, to obtain the adhesive film.

18. The method of claim 17, wherein the curing is carried out at a temperature of 150° C. or lower, preferably 140° C. or lower, more preferably 130° C. or lower, more preferably 120° C. or lower, for a period of less than 10 minutes, preferably within 5 minutes.
